(19) United States
(12) Patent Application Publication
(10) Pub. No.: US 2015/0124921 A1
(43) Pub. Date: May 7, 2015

(54) Downhole Gamma Ray Source Using Neutron Activation

(71) Applicant: Schlumberger Technology Corporation, Sugar Land, TX (US)

(72) Inventors: Joel Groves, Leonia, NJ (US); Christian Stoller, Princeton Junction, NJ (US)

(73) Assignee: Schlumberger Technology Corporation, Sugar Land, TX (US)

(21) Appl. No.: 14/072,119

(22) Filed: Nov. 5, 2013

(51) Int. Cl. G01V 5/12; G21G 4/02

(52) U.S. Cl. CPC G01V 5/12; G21G 4/02
USPC 376/160; 376/158

(57) ABSTRACT

A method is for creating a gamma ray source downhole by creating a radioactive material through irradiation of an inert material by high energy neutrons, wherein the material to be activated may surround the neutron source in close proximity to form a compact gamma ray source. The gamma rays generated by the activation may be used to perform nuclear measurements downhole.

### FIELD OF THE DISCLOSURE

This disclosure related to well logging, and more particularly, to gamma-gamma density logging using a short-lived radioisotopic source created in a downhole tool.

### BACKGROUND

For more than 50 years, accurate measurements of the formation density have been performed using gamma ray scattering in the formation. The traditional gamma-gamma measurement uses a radioisotopic source, typically ¹³⁷Cs, inserted in the logging tool that emits gamma rays into the formation. The returning gamma rays are measured by one or more gamma ray detectors and an accurate density is determined from the observed count rates. Density logging is one of the most used measurements made in borehole logging. Density information of the formation surrounding a borehole is crucial for an accurate determination of formation porosity and therefore an essential part in the computation of reserves.

Typical gamma ray logging sources have activities of 10 to 100 GBq and their use, transportation, handling and storage have significant implications for safety, tracking and security. It is therefore advantageous to replace the logging source by a radiation emitter that can be controlled and turned off.

Work on x-ray generators for downhole use has been ongoing for decades. Examples of this effort can be found in US Patents for DC x-ray-based and pulsed x-ray sources such as U.S. Pat. Nos. 5,122,662, 7,638,957, 7,564,948 assigned to Schlumberger. At present, there is no commercially available electronic source of gamma-rays or x-rays that can replace the ¹³⁷Cs radioisotopic source used for density logging.

There have been proposals to use charged particle reactions such as X(p,p′) X, ^{A}X(p,n)^{A-1}X, ^{A}X_{Z}(d,n)^{A+1}X_{Z+1}, etc., where X designates an irradiated isotope with mass number A. Most of these charged particle reactions have small cross sections at particle energies <1 MeV, which may be achievable in a downhole tool, and generate gamma rays of energies of several MeV, which are less suited for density measurements because of the drop in the Compton scattering cross section and the increased contribution from electron-positron pair creation.

There is therefore a need to find alternative approaches to generate mono-energetic gamma rays for density logging.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A first application is directed towards a method of generating gamma rays in a downhole tool through activation of a material surrounding a switchable neutron source. A neutron source is used to generate a radioactive gamma ray emitter in proximity to the neutron emitter through the transmutation of nuclei in the material through neutron reactions. An example is a reaction, in which an energetic incoming neutron interacts with a target nucleus by knocking out a neutron, thus lowering the mass number and the neutron number of the nucleus by one.

A second application is directed towards using the gamma ray source generated through activation as the source of gamma rays for a gamma-gamma density measurement, thus eliminating the need for a long-lived radioisotopic source.

In a third embodiment, the gamma ray density measurement is equipped with additional detectors to allow accurate compensation for activation in the borehole and the formation.

In a forth embodiment, the gamma ray density measurement is combined with neutron measurements using the neutrons from the neutron source for neutron induced nuclear measurements.

In a further embodiment, activated gamma ray source is combined with a gamma ray detector on the opposite side of the mud channel in a logging-while-drilling (LWD) tool, to measure the density of the mud in the mud channel.

### BRIEF DESCRIPTION OF THE DRAWINGS

FIG. 1 shows a schematic outline of the proposed radiation generator.

FIG. 2 shows an example of the buildup of activation.

FIG. 3 shows an example of the buildup and decay of activation for the isotope ⁶³Cu.

FIG. 4A and FIG. 4B show two embodiments of the activation target of the invention.

FIG. 5 shows a possible embodiment of the target with a collimating opening.

FIG. 6 shows a possible apparatus for downhole density logging, which makes use of the radiation generator of the invention.

FIG. 7 shows a simplified pulsing scheme of the pulsed neutron source of the invention, which includes a long pause to allow for the measurement of activation induced gamma rays.

FIG. 8 shows an LWD gamma-gamma density tool with a detector for compensation of formation activation.

FIG. 9 shows cross sections at the pulsed neutron generator and at one set of detectors of the tool of FIG. 8.

FIG. 10 shows a tool in which the activation-based gamma-gamma density section is complemented by a neutron measurement section.

FIG. 11 shows a tool, in which the activated source is used for a mud density measurement in the mud channel of an LWD tool.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers separated by century refer to like elements throughout.

The invention shows ways to overcome the limitations in the generation of gamma-rays using charged particle reactions such as ^{A}X(p,p′) ^{A}X at charged particle energies <1 MeV that may be achievable in a downhole accelerator. The low cross sections for most charged particle reactions are largely due to the fact that in order to react with the target nucleus the incoming particle needs to overcome the Coulomb barrier, i.e. the repulsive force exerted by the positively charged nucleus on the positively charged incoming particle.

If the incoming particle is a neutron, this issue does not present itself. Generally neutron cross sections for a multitude of neutron interactions are much higher than those found for low energy charged particle interactions. It is therefore advantageous to consider a two-step interaction, in which neutrons are generated by a neutron generator and the neutron beam interacts with a selected target material to generate gamma rays.

It has been proposed in the past that the neutrons generated in such a way could directly generate inelastic or capture gamma rays in a logging tool, which could, in turn, be used for a gamma-gamma density measurement (U.S. Pat. No. 8,440,961). This approach is handicapped by the fact that only a small fraction of the total number of gamma rays is generated in the target in the tool by inelastic or capture reactions. A large part of gamma rays will be generated in other parts of the tool, the surrounding borehole and formation. Therefore, a non-negligible fraction of the gamma rays detected in a detector located in the tool may be caused by a neutron interaction in the tool, borehole, formation or the detector itself.

The above mentioned shortcomings are overcome with the present invention, which uses neutron activation to generate a source of gamma rays in the tool and only a minimal activation signal in the formation. Optimized timing can be used to eliminate any contributions from inelastic and capture gamma rays and to minimize the contribution from activation in the surrounding formation. While the use of activation has been proposed previously (US Patent application 2012/0318968). This invention assumes that generation of activation happens in the ⁵⁶Fe of the drill collar.

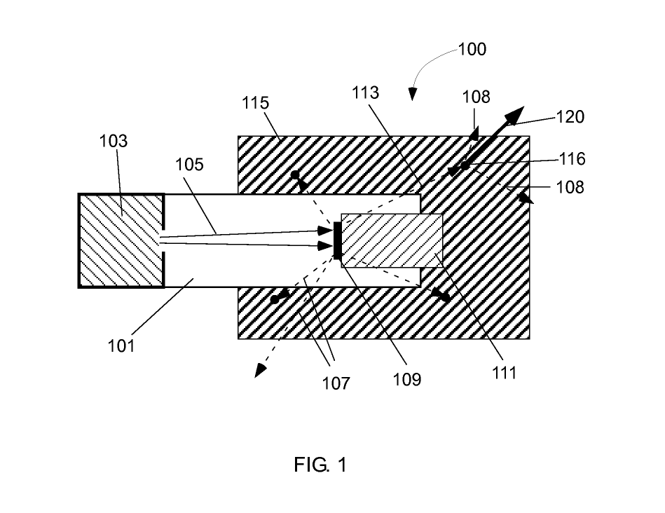

FIG. 1 shows the basic idea of the gamma ray generator. The gamma rays are generated by activating a material 115 surrounding the neutron source 109, which is the target in the neutron generator tube 101, in close proximity. This leads to the creation of a compact, short-lived gamma ray source, which can be used for the purpose of a gamma-gamma density measurement or any other measurement that may require the use of a radioisotopic gamma ray source, such as a measurement of the photoelectric factor Pef of the formation or the borehole. With the right choice of material, a large amount of neutron activation can be achieved and the gamma ray output may be as high as or higher than 20% of the neutron output. This means that by generating 10⁹ neutrons/s it may be possible to obtain 2×10⁸ gamma rays/s from the source.

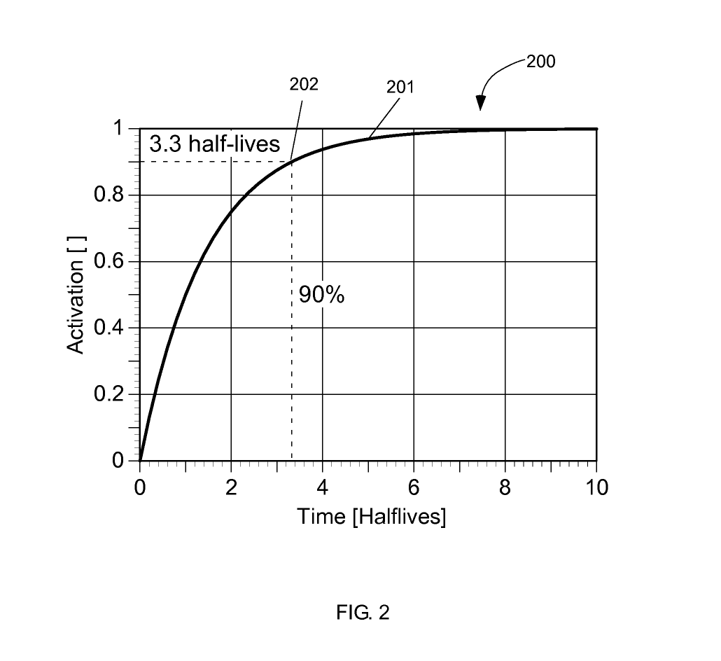

If a d-T generator is used as the source of the activating neutrons, the highest cross sections for activation can be found in ^{A}X(n,2n)^{A-1}X reactions. In this reaction, a fast neutron interacts with a nucleus of an isotope with mass number A of an element X in the material surrounding the neutron-emitting target and transforms it into an isotope of the same element with one less neutron and therefore a mass number A−1. For the purpose of this application it is desirable to have a target isotope that has a large abundance, i.e a large isotopic number density (Number of atoms of a given isotope per cm³) and a large activation cross section. The half-life of the activated material should be as short as possible in order to obtain full activation in as short a time as possible. Plot 200 in FIG. 2 shows the activation process as a function of time for an activation product with a given half-life. The activation N_{act}(t) 201 builds up as a function of the time t with a charging function shown in equation (1)

$${N}_{act} ( t ) = c \cdot {N}_{n} \cdot ( 1 - {e}^{- \frac{t \cdot ln ( 2 )}{{T}_{1 / 2}}} ) \qquad ( 1 )$$

where c is a constant, Nₙ is the number of high energy neutrons emitted by the source and T_{1/2} the half-life of the isotope generated in the interaction. It takes about 3.3 half-lives to reach 90% of the asymptotic value of the activation 202.

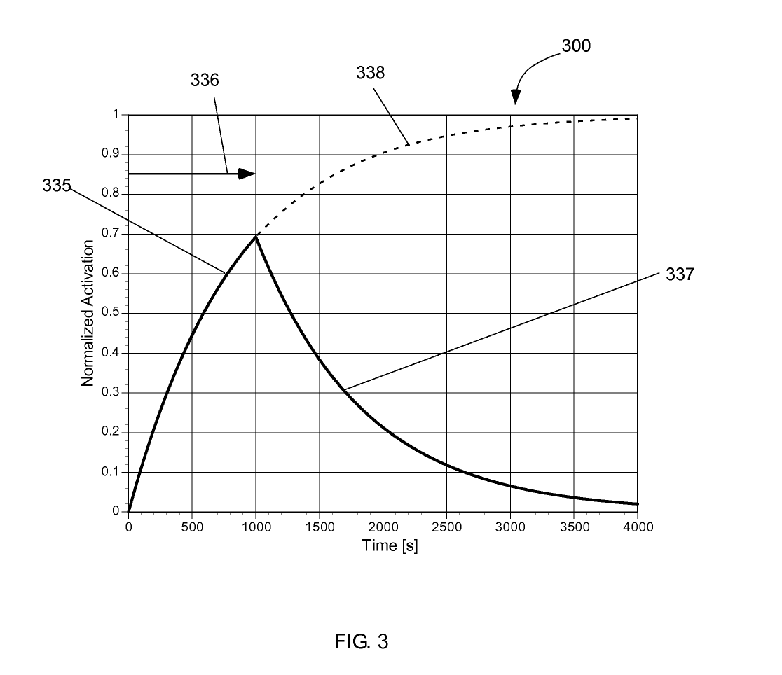

FIG. 3 shows the process of activation and decay for the isotope ⁶³Cu, which may be converted to ⁶²Cu in the reaction ⁶³Cu(n,2n)⁶²Cu. ⁶²CU is unstable and decays to ⁶²Ni through electron capture and positron emission (⁺) with a half-life of 9.8 min or 588 s. Plot 300 of FIG. 3 shows the activation and decay assuming an activation time 336 of 1000 s during which the activity 335 increases, followed by the decay 337 after the end of activation. Dashed curve 338 shows the evolution of activation if it had continued beyond 1000 s.

A list of isotopes with large (n,2n) cross sections for 14 MeV (d-T generated) neutrons is provided in table 1. As mentioned above, suitable isotopes are those with a large activation cross section, large isotopic abundance, high gamma ray yield and a high (number) density. The table summarizes the principal gamma ray emissions and their yield, i.e. the % of decays resulting in the emission of gamma rays. The macroscopic cross section represents the cross section in the element (solid state, room temperature density) for a thickness of 1 cm. In order to obtain the relative gamma ray yield, one multiplies the macroscopic cross section by the gamma ray yield. Based on the cross section alone, Pr would be the preferred element. If one takes into account the gamma ray yield, then Cu is equally good if not better. The last rows of the table provide a comparison with the expected activation yield for a different kind of neutron reaction such as the ²⁸Si(n,p)²⁸Al reaction. Obviously, other reactions such as (n,)-reactions like ²⁷Al(n,)²⁴Na may be considered as well.

TABLE 1
List of some (n,2n) reactions with large cross sections and half-lives <100 d.
The last lines show the comparison with the ²⁸Si(n,p)²⁸Al and ⁵⁶Fe(n,p)⁵⁶Mn reactions.

| | | | | | | | Macroscopic |
|---|---|---|---|---|---|---|---|
| | | | | | Daughter | Gamma | cross |
| | Abundance | σ | Product | | gammas | yield | section |
| Nuclear Reaction | (%) | (b) | Half-life | | (keV) | (%) | (cm⁻¹) |
| ⁶³Cu(n,2n)⁶²Cu | 69.5 | 0.52 | 9.8 | min | 511 | 195 | 0.031 |
| ⁶⁵Cu(n,2n)⁶⁴Cu | 31 | 0.96 | 12.7 | h | 511 | 38 | 0.025 |
| ⁶⁹Ga(n,2n)⁶⁸Ga | 60 | 0.96 | 68 | min | 511 | 176 | 0.029 |
| ⁷⁵As(n,2n)⁷⁴As | 100 | 1.06 | 17.8 | d | 511, 596, | 59, 61, | 0.049 |
| | | | | | 635 | 14 | |
| ⁷⁹Br(n,2n)⁷⁸Br | 51 | 0.93 | 6.4 | min | 511, 614 | 184, 14 | 0.011 |
| ⁸⁵Rb(n,2n)⁸⁴Rb | 72 | 1.4 | 34 | d | 511, 881 | 42, 74 | 0.011 |
| ⁸⁷Rb (n,2n)⁸⁶Rb | 28 | 1.8 | 18.7 | d | 1076 | 72 | 0.0053 |
| ¹²¹Sb (n,2n)¹²⁰Sb | 57 | 1.1 | 5.8 | d | 160, 511 | 87 | 0.021 |
| ¹²³Sb (n,2n)¹²²Sb | 43 | 1.6 | 2.7 | d | 564 | 66 | 0.023 |
| ¹²⁷I(n,2n)¹²⁶I | 100 | 1.6 | 13.0 | d | 388, 666 | 34, 33 | 0.37 |
| ¹³³Cs(n,2n)¹³²Cs | 100 | 1.5 | 6.5 | d | 668 | 99 | 0.013 |
| ¹³⁸Ba (n,2n)¹³⁷Ba | 72 | 1.0 | 2.5 | min | 661 | 89 | 0.011 |
| ¹⁴⁰Ce (n,2n)^{139m}Ce | 88.5 | 1.4 | 56 | s | 746 | 93 | 0.031 |
| ¹⁴¹Pr (n,2n)¹⁴⁰Pr | 100 | 1.8 | 3.4 | min | 511 | 102 | 0.052 |
| ²⁰⁸Pb (n,2n)²⁰⁷Pb | 52 | 1.6 | 800 | ms | 570, 1063 | 99, 83 | 0.0127 |
| ²⁸Si(n,p)²⁸Al | 92 | 0.25 | 2.3 | min | 1780 | 100 | 0.0127 |
| ⁵⁶Fe(n,p)⁵⁶Mn | 92 | 0.11 | 2.58 | h | 847, 1811, | 99 (@847) | 0.0086 |
| | | | | | 2113 | | |

¹⁴¹Pr looks like a very good candidate for this type of electronic gamma-ray source. The (n,2n) cross-section is the largest of all listed and the isotopic abundance of ¹⁴¹Pr is 100% and there are 1.02 511-keV gamma rays/decay (The ⁺-decay results in the emission of two 511-keV gamma rays from annihilation, but only 51% of the decays of ¹⁴⁰Pr are ⁺-decays). In addition, the ¹⁴⁰Pr radioisotope produced by the (n,2n) reaction has a very short half-life of 3.4 minutes. The short half-life means that the activated isotope will reach saturation or maximum gamma-ray emission in a few minutes after the start of the neutron generation and, when the 14 MeV neutron generator is turned off, the ¹⁴⁰Pr will rapidly decay away in about 30 minutes. In 10 half-lives (34 minutes), the radioactivity will be reduced by a factor of 1/1024.

A closer look at Table 1 shows that the gamma ray emission probability is about the same for the activation of Cu as for Pr. In the case of ⁶²Cu, almost 100% of the decay is + and therefore there are almost 2 gamma rays per decay. If one multiplies the macroscopic cross section with the gamma ray emission probability, one finds that Cu will emit more 511-keV gamma rays than Pr for the same thickness of material and the same activating neutron flux.

Pr has the advantage of a shorter half-life but it also has a several disadvantages. The material is more expensive and it is a poor conductor of heat. This may be a significant issue, since the bombardment of the target in the generator may lead to significant heat dissipation of 1 Os of watts. In order to avoid excessive target temperatures the heat may be evacuated. Another consideration is the fact that it may be desirable for gamma rays to exit the material without being scattered. This limits the thickness of the target material that can be used. For 511 keV gamma rays, the probability of scattering when traversing 1 cm of the material, is about 50% for both Cu and Pr, so in this respect Cu and Pr are equivalent.

The last two rows in Table 1 show the (n,p) reactions, which lead to activation of ²⁸Si and ⁵⁶Fe. The cross section is significantly smaller than for the activation of Cu or Pr through the (n,2n) reaction. However, the gamma ray energy is higher and, in the case of silicon, the density of the material is lower, so absorption is lower. The probability of scattering in 1 cm of material for the 1780-keV gamma rays from the decay of ²⁸Al is 12%. This allows the use of thicker material and therefore for comparable gamma ray emission. In addition, the ²⁸Si(n,p)²⁸Al cross section is almost constant for neutron energies between 7 and 16 MeV, while the ⁶³Cu(n,2n)⁶²Cu cross section drops rapidly with decreasing neutron energy.

FIG. 1 shows a possible way for providing an activation-based source of gamma-rays 100. The neutron generator comprises a high voltage supply (not shown) and a neutron generator vacuum tube 101 with ion source 103, target 109 and target support 111. The charged particle deuteron or triton beam 105 is directed at the target 109, where the d-T reaction d(t,)n leads to the emission of 14-MeV neutrons 107. The target typically may be a metal hydride such as titanium with bound tritium or deuterium. Examples of alternative metal hydrides that may be used are among others hydrides of scandium, zirconium or palladium. In particular for high output targets, the use of titanium may not be optimal given that it releases bound tritium at temperatures above about 200° C.

The generator tube 101 may be surrounded by material 115 that may be activated. Fast neutrons 107 traversing the material may interact with a nucleus 116 and may be converted to an activated isotope. Two neutrons 108 may be emitted in the case of an (n,2n) reaction with the target nucleus. The converted isotope may eventually decay by the direct or indirect (positron annihilation) emission of gamma rays. The number and energy of emitted gamma rays is a function of the activated isotopes and may be as high as 2 or more per decay, while in other cases only a fraction of a gamma ray may be emitted during the decay of an activated nucleus.

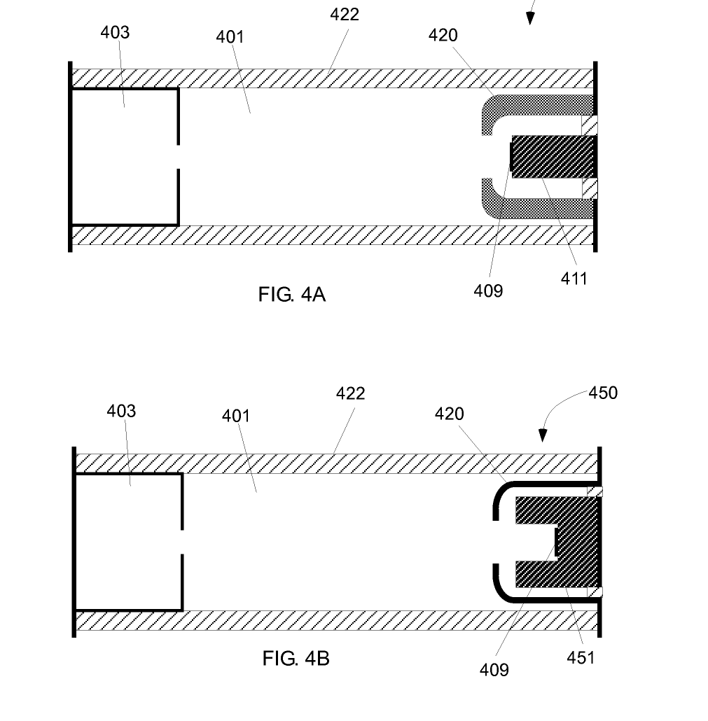

In some radiation generator tubes the target support 111 is made of copper in order to provide an electrical connection to the high voltage supply (not shown) and often more importantly to evacuate the heat generated by the particle beam impinging on the target. Therefore, the target may be shaped in such a way as to enhance the production and emission of activation gamma rays. Two embodiments are shown in FIG. 4A and FIG. 4B. In this case, some of the structural materials of the generator vacuum tube may be used for the production of activation gamma rays. The schematic sketch 400 in FIG. 4A shows the layout of a typical generator tube 401 consisting of ion source 403, housing 422 with a suppressor electrode 420, target 409 and target support 411. One or both, the suppressor and the target support may be made of a material suitable for activation such as Cu or Pr. Preferably, the two materials may be the same but it may be possible to make the target support out of Cu and the suppressor out of Pr for example. Additionally, the tube 401 may be surrounded by additional material that may be activated.

The device 450 in FIG. 4B shows a similar arrangement of a generator tube 401 with ion source 403, housing 422, suppressor 420, target 409 and target support 451. In this case, the target may be recessed in the larger diameter target support, which may be made of an activating material such as Cu. This may enhance the amount of activating material at the closest distance to the neutron source, therefore concentrating the gamma ray emission in a small region. This may be advantageous for a formation density measurement, which may preferably use a gamma ray source occupying a small well defined volume. It should be understood that in this example the suppressor 420 may be made of an activating material and that the vacuum tube 422 may be surrounded by additional activating material.

In some cases, where it may be desirable to have gamma ray emission in a preferred direction, the target may not be surrounded symmetrically by activating material. Rather, the activating material may be placed preferably on the side from which gamma ray emission is desired. To enhance gamma ray emission further, the side away from the gamma emission may be equipped with a neutron reflecting material such as beryllium to direct some of the neutrons back towards the activator. This may be particularly useful if the activating material has a low activation energy threshold and reflected neutrons have a high probability of causing activation.

In yet another embodiment, the activation material may be partially or entirely surrounded by a reflector to return some of the neutrons that have traversed the activation material back to it. Beryllium or Aluminum may be particularly suited as they have low gamma ray scattering cross sections and the reflector has only a small impact on the intensity of the emitted gamma rays.

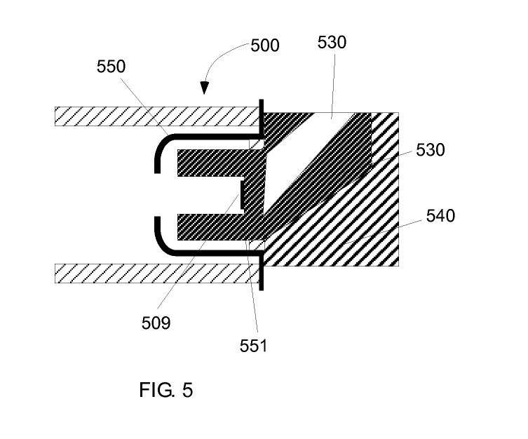

In yet another embodiment, better directionality of the gamma ray emission may be obtained by providing an opening or collimator in the activating material in the direction of interest. A possible layout is shown in FIG. 5. The sketch 500 shows the target area of a neutron generator tube. The activation material 551 and 530 is arranged to provide a large amount of activation. An opening 530, which may have a circular cross section, is provided to allow gamma rays originating close to the target to be preferably emitted in one direction. The additional activation material 530 enhances gamma ray emission in the direction of interest. An optional reflector 540 may be used to increase activation in particular in the material 530.

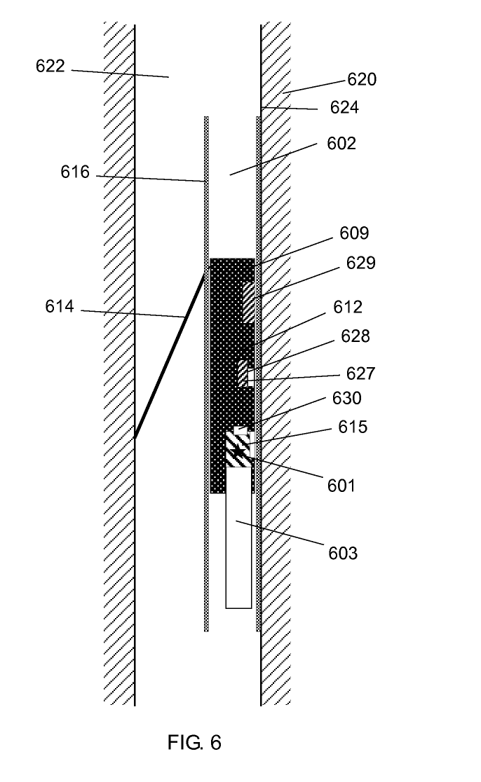

FIG. 6 shows a possible downhole tool 602 incorporating the activation gamma ray source for the purpose of a gamma-gamma density measurement. The downhole tool comprises a pressure housing 616, which is pushed against the borehole wall 624 and formation 620 by a backup arm 614. The housing contains the pulsed neutron generator, which contains the neutron generator tube and its target 601 surrounded by the activation material 615. The generator 603 and the detectors 627 (short spaced) and 629 (long spaced) are embedded in shielding 609 such as tungsten to prevent direct passage of gamma rays and neutrons from the neutron source 601 and the activation material 615 respectively to the detectors. Short spaced (SS) detector 627 is recessed in the shielding and gamma rays may arrive at the detector through a collimating opening 628. The long spaced (LS) detector 629 may be positioned as close to the surface of the shielding 609 as possible to maximize the count rate. Typical spacings for the SS detector 627 may be about 10 to 20 cm from the activation source 615, while the LS detector 629 may be positioned between 20 and 60 cm as an example. Since it may be helpful to normalize the detected count rates to the activation and therefore the gamma ray output of the activation material 615, a gamma ray monitor detector 630 may be added to the tool. This detector may be a spectroscopy detector or a gamma ray counting detector. Further refinement may be obtained through the use of a neutron monitor detector (not shown) close to the target (neutron source) 601.

In order to determine the activating flux of neutrons, a neutron monitor may be used to estimate the activation in the absence of or in conjunction with a gamma-ray monitor. In addition, a neutron monitor may be used to obtain a better estimate of formation activation, due to the knowledge of the activating flux.

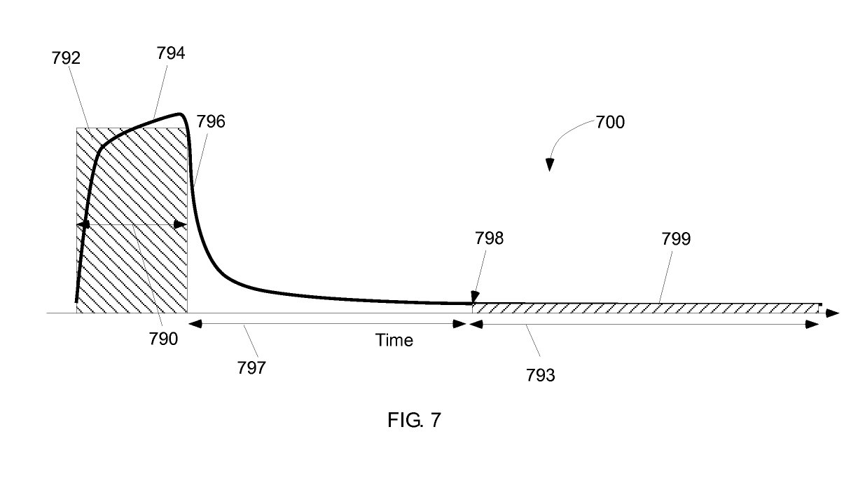

In order for the apparatus to work and to allow a clear distinction between gamma rays from activation and gamma rays from inelastic scattering of neutrons or neutron capture, special timing of the neutron pulses may be adopted to allow for sufficient time between neutron pulses for capture gamma rays to completely die away before the measurement starts. Diagram 700 in FIG. 7 shows a simple bursting scheme with the neutron burst 792, i.e. the time during which the generator emits neutrons. During the time 790 of the burst, the burst count rate 794 may increase due to the inelastic counts and the buildup of thermal and epithermal capture counts. Once the burst stops, emission of gamma rays due to inelastic neutron interactions stops and the count rate 796 from capture decreases and, after 1 to 2 ms, capture gamma rays may have died away, the remaining gamma rays 799 result from the activation of the activation material and, to a lesser extent, some activation in other materials in the tool, the borehole and the formation.

The density measurement may take place during the time 793, following the die-away of inelastic and capture gamma rays 794 and 796. Additional measurements such as inelastic and capture gamma ray spectroscopy and the measurement of the macroscopic thermal neutron capture cross section may be made during the burst 792 and during the time interval 797 following the burst, during which capture gamma rays may be present. It should be understood that the burst 792 may be subdivided into a series of microbursts to allow additional measurements. As an example, the burst 792 could be divided in 1000 bursts of 20 s length separated by an 80-s pause. This would result in a 0.1-s long macroburst, which may be followed by a 2-ms decay time and a 0.2-s measurement time. Thus providing a duty cycle, i.e. fraction of available time, of about 67% for an activation-based measurement and 33% for other neutron measurements.

Many other pulse sequences are possible, as long as they allow for enough time for the activation based measurement. The pulse sequence or the time gates for the measurements may be adjusted based on the decay of the capture counts. In particular, in high salinity environments, the capture events decline in a time much shorter than 2 ms and the additional available time may be used for a density measurement or another activation based measurement. The limits for the time gates may be based on the die-away of the capture gamma rays and on the macroscopic thermal neutron capture cross section of the formation, commonly known as sigma, or the borehole derived from the die-away. In addition, the pulsing scheme may be adapted based on measurements such as sigma.

Additional detectors suited for other measurements may be added to the tool. Such detectors may be neutron detectors (fast neutron, thermal or epithermal as an example) or gamma ray detectors or a combination thereof for the determination of formation lithology, fluid determination, sigma, neutron porosity to name a few.

Since the neutrons may not only activate the material directly surrounding the target but also other materials in the tool, the surrounding borehole and the formation, there may be a need to correct for counts from such activation. Also, the tool layout can be optimized to reduce this effect through added shielding and selection of materials with low activation cross section for example. Also it may be advantageous for the detectors associated with the activation based measurement to be leading the neutron source with respect to the tool motion in order to minimize the impact of formation and borehole mud activation.

The main activation products in the borehole and the formation that may be seen by the detectors are ¹⁶N (activated oxygen) with a half-life of 7 s and ²⁸Al from the activation of ²⁸Si and ²⁷Al (half-life 2.3 min). If the activation gamma ray source in the tool emits 511-keV gamma rays the correction for formation and borehole activation may be based on the detection of high energy gamma rays (Oxygen 6.13 MeV, Silicon 1780 keV). If Si were the activated element in the tool it may still be possible to apply a similar correction since the gamma rays scattered back to the detectors may have energies, which are much lower than those of gamma rays originating in the formation or borehole, which may have traveled to the detectors without scattering.

As indicated in FIG. 6 for example, gamma rays originating from the activation source may be able to reach a detector located in the tool after having scattered at least once, since the direct path from the source 615 to the detector 627 or 629 is blocked by shielding material 609. Activation gamma rays originating in the formation or the borehole may reach the detector on a direct path and may, on average, have higher gamma ray energy.

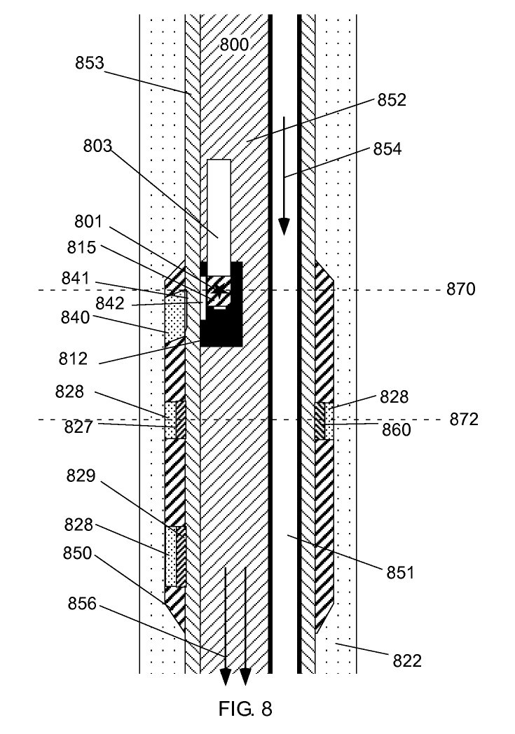

In order to determine the contribution to the gamma ray signal from activation of the borehole and the formation, one or more detectors not facing in the direction of the principal gamma ray emission may be used to obtain a more accurate estimate of the activation. FIG. 8 shows an example of a gamma-gamma density measurement in an LWD tool 800, which comprises a tool chassis 852 with an off-center mud channel or flow tube 851 with the mud 854 flowing down. The neutron generator 803 is installed in the chassis 852. The neutron source 801 is surrounded by activation material 815, which may be surrounded by shielding material 812. An example of such a shielding material, which may be effective in shielding neutrons and gamma rays, is tungsten. An opening 842 in the shielding material facilitates the emission of the gamma rays from the activation material in a preferred direction. Further, a thinned section 841 of the collar 853 may enhance the gamma ray transmission. A window 840 in the stabilizer 850 may be used to facilitate gamma ray transmission to the formation and may be used to provide desired angular and axial collimation to improve the density measurement that may be performed by the at least two detectors 827 and 829, which may be placed in or under the stabilizer 850 behind windows 828. As indicated previously, the detectors are leading the neutron source during drilling or reaming down. The direction is indicated in FIG. 8 by arrows 856.

In addition, to the detectors 827 and 829 for the gamma-gamma density measurement, at least one additional detector 860 may be placed at the opposite side of the tool or at least at an azimuth, where it may not be affected by the gamma rays emitted by the activation source 815, since the shielding 812 and possible additional shielding (not shown) between the back detector 860 and the activation source may prevent gamma rays from the activation source 815 from reaching the detector 860, which may preferably be placed at the same axial distance from the source 815 as the short spaced detector 827. The detector 860 may be used to measure the activation induced in the formation so that, with proper scaling, it can be subtracted from the signal registered in the short spaced detector 827 and the long spaced detector 829. The results may be further enhanced by positioning additional detectors (not shown) preferably at the same azimuth as detector 860 at the same axial distance from the source 815 as the long spaced detector 829.

In order to enhance the precision, more than one detector 827 and 829 may be placed at closely spaced azimuths at the short spaced and the long spaced position. Shielding may be added between multiple detectors 827 or 829 azimuthally to minimize double counting gamma rays that may get detected in more than one of the adjacent detectors. Alternatively, electronic anticoincidence circuitry may be used to achieve the same goal.

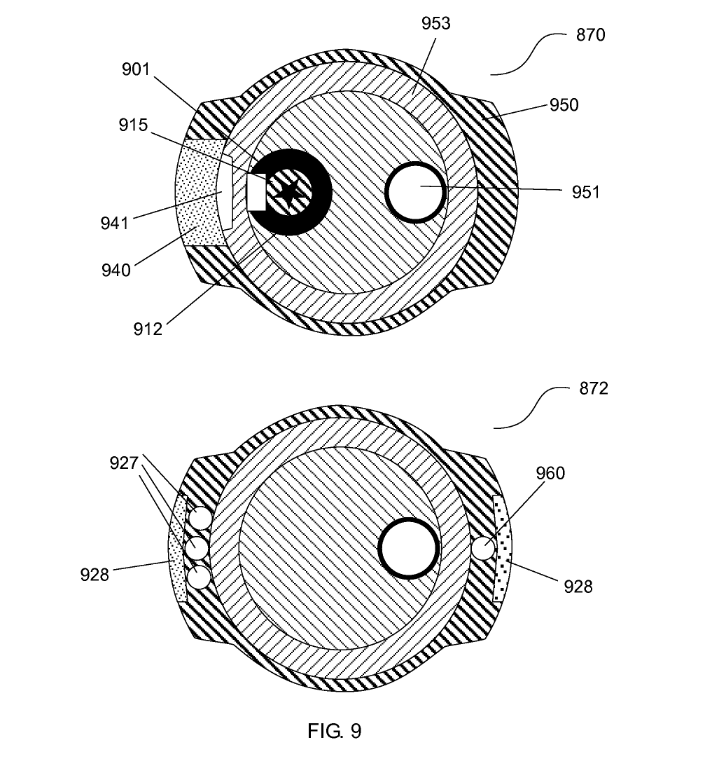

FIG. 9 shows cross sections through the tool 800 at two different axial positions 870 and 872 indicated in FIG. 8. Axial position 870 coincides with the neutron source 801 and axial position 872 coincides with the axial center of the short spaced detector 827. The example shows three short spaced detectors 927 at the same axial spacing and a single short spaced back detector 960 at 180° with respect to the azimuth of the center short spaced detector. The “back” detector 960 may be placed at a different angle with respect to the axis of the tool and the position of the detector 927. Such angles may be 90°, 120° or any other suitable angle, at which the detector will not detect gamma rays from the activation source due to the shielding 912 around the activation source 915. E.g. if three stabilizer blades 950 were used instead of the two indicated in the drawing, an angle of 120° may be appropriate. In order to improve the statistics of the detection of formation and borehole activation, more than one “back” detector 960 might be used. Windows 928 may be provided in front of detectors 927 or 960 to enhance gamma ray transmission to the detectors.

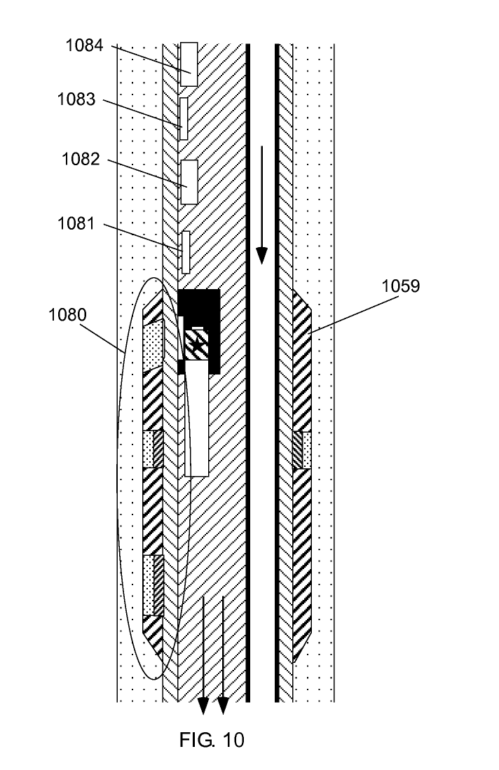

A tool using an activation density measurement may be enhanced by complementing it with a full set of neutron measurements as outlined in U.S. Pat. Nos. 7,073,378 and 7,334,465. This is outlined in FIG. 10, which shows an example of a logging-while-drilling tool combining an activation gamma ray measurement 1080 with a neutron porosity measurement, neutron-gamma spectroscopy measurement, sigma measurement, neutron gamma density measurement for example. The tool includes the density section 1080 described previously and an example neutron section comprising detectors at 4 different axial spacings with one or more near neutron detectors 1081, one or more short spaced gamma ray detectors 1082, one or more far neutron detectors 1083 and one or more long spaced gamma ray detectors 1084, where the neutron detectors may be thermal or epithermal neutron detectors.

In yet another embodiment (not shown), the neutron measurements may be located in the stabilizer 1059 of FIG. 10 or collar on the opposite side from the neutron source for a more compact tool and enhanced collocation of the nuclear measurements.

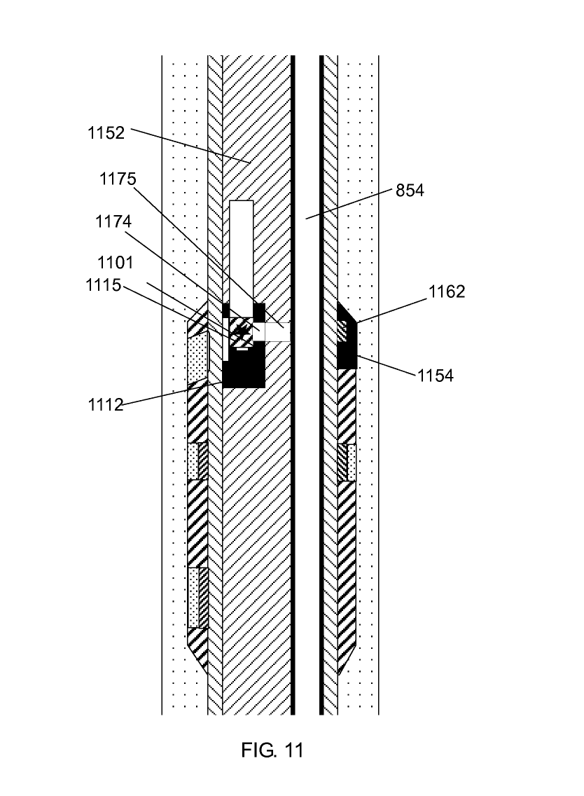

In yet another embodiment, in an LWD tool shown in FIG. 11, there may be at least one gamma ray detector 1162 diametrically opposite from the gamma ray source, so that the gamma rays from the source traverse the flow tube or mud channel before reaching the detector. Given the known output of the gamma ray source it may be possible to determine the attenuation of the gamma rays in the mud channel 854 and from this measurement to determine the density of the mud or the photoelectric factor of the mud. Gamma ray shielding 1154 may be placed behind detector 1162 to reduce the signal from activation of the formation and the borehole. In order to enhance the gamma ray signal and to reduce scattering in the collar, an opening or window 1175 is made in the chassis 1152. Also, there is an opening in the shielding 1112 around the activation source 1115 to allow passage of the gamma rays. One or more additional detectors (not shown) may be positioned at an axial distance from the at least one gamma ray detector and shielded from the direct gamma rays from the gamma ray source to allow subtraction of the gamma ray contribution from activation of the formation, borehole and downhole tool.

Alternatively, to the concept shown in FIG. 11, an activation target could be placed very close to the mud channel or flow tube so as to provide a gamma ray source next to the mud channel. Such a target may be equipped with a gamma ray monitor to provide a measurement of the targets gamma ray flux.

While the mud density measurement above has been described in terms of a measurement in a logging while drilling tool, a borehole mud density measurement could be made in other tools provided they have at least one opening that allows mud to enter in a cavity in the tool, allowing the passage of gamma rays. In a mandrel configuration tool, the activation target may be mounted in the mandrel and the one or more detectors may be mounted in the collar surrounding the mud channel and the mandrel. A gamma ray monitor may be mounted inside the mandrel next to the activation target or outside the mandrel in the collar, wherein the gap formed by the mud channel may be filled by a solid gamma ray transparent material such as polyether ether ketone (PEEK) between the activation target and the activation monitor over a limited axial length and azimuthal opening in order not to impede the mud flow. The transparent material may be part of the shock mounting of the mandrel in the LWD tool.

While the gamma ray generation has been described mainly in terms of an (n,2n)-reaction other suitable reactions such as ²⁸Si(n,p)²⁸Al can be used as well. Also, several activation materials can be mixed or placed strategically at different positions depending on the desired gamma ray spectrum or considerations regarding the energy dependence of the activation cross section. Materials, the activation cross section of which decreases less with decreasing neutron energy could favorably be put at a farther distance and the intervening room filled with a material with a larger cross section, which drops off more quickly as the neutron energy decreases.

While the examples indicate a wireline tool and an LWD tool, the invention can be used with any mode of conveyance of a downhole tool, such as wireline, drill pipe, slick line, through-drill-pipe to name a few.

The data processing may be done entirely by a processor in the downhole tool using a microprocessor, digital signal processor (DSP) or a field programmable gate array (FPGA) or a combination thereof for an example. Some or all of the data may be transmitted to a computer or processor at the surface, which may further process the data. The data transmission to the surface may be done through mud telemetry, wired drill pipe, electromagnetic transmission, wireline or fiber optic to name a few. The data at the surface may further be transmitted to other processors such as computers at a computing center, a client office etc. by wired or wireless data transmission. Further data processing and analysis may be performed there on a single computer or multiple processors.

Data may be stored in the downhole tool, in particular if all the data cannot be transmitted to the surface in real time. The data may be stored in storage media such as flash memory, DRAM or SRAM. When the tool returns to surface the data may be transferred to a surface computer connected to one or more storage devices such as a magnetic hard drive, a solid state drive, DVD or CD etc. The storage device may be attached to the surface computer or may be remote.

The data stored in the tool may be read out at surface or downhole and transferred to a processor for processing and analysis. Surface read out may be through a wired connection or wireless. Downhole read out may be obtained by coupling the downhole tool memory to a readout tool present in the hole, where such coupling may be wireless, wired or acoustic for example.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

1. A method for creating a gamma ray source in a downhole tool comprising:
generating neutrons in a neutron generator;
surrounding the neutron generator by an activation material;
irradiating the activation material with neutrons from the neutron generator;
creating radioactive nuclei in the activation material through neutron reactions;
generating gamma rays from the decay of the radioactive nuclei generated by the neutron irradiation.

2. The method of claim 1, wherein the neutron generator is a pulsed neutron generator.

3. The method of claim 2, wherein the neutrons are generated by a d-T reaction.

4. The method of claim 1, wherein the activation reaction comprises a reaction from the group consisting of (n,2n), (n,p) and (n,).

5. The method of claim 4, wherein the activation reaction comprises one or more reactions from the group consisting of ⁶³Cu(n,2n)⁶²Cu, ¹⁴¹Pr(n,2n)¹⁴⁰Pr, ¹⁴⁰Ce(n,2n)¹³⁹Ce and ²⁸Si(n,p)²⁸Al.

6. The method of claim 1, wherein the neutron generator includes a neutron target, from which the neutrons are emitted, a neutron target support carrying the neutron target, and a suppressor electrode adjacent the neutron target; and wherein the neutron target support or the suppressor comprises the activation material.

7. The method of claim 1, wherein the neutron generator comprises a neutron generator tube;
and wherein the neutron generator tube is surrounded by the activation material; and
wherein the activation material comprises one or more activating materials.

8. The method of claim 1, wherein the activation material has an opening to facilitate emission of gamma rays from the activated material.

9. The method of claim 1, wherein a gamma ray detector is located proximal to the activated material to determine an activation.

10. The method of claim 1, wherein the neutron generation is measured with a neutron monitor.

11. The method of claim 2, wherein the pulsed neutron generator operates according to a neutron pulsing scheme, which includes a gap in the neutron generation, which is longer than the time for capture gamma ray emission to cease.

12. A method to perform a gamma-gamma measurement downhole using an activation source as a source of gamma rays, the method comprising:
generating neutrons in a neutron generator;
activating material surrounding the neutron generator with the neutrons to form a radioisotopic source;
irradiating the formation with gamma ray radiation from the radioisotopic source;
measuring scattered gamma rays in at least two gamma ray detectors;
in a processor determining a property of the formation based on the measurements of the at least two gamma ray detectors.

13. The method of claim 12, wherein the neutron generator is a pulsed neutron generator.

14. The method of claim 13, wherein the pulsed neutron generator operates according to a neutron pulsing scheme, which includes a gap in the neutron generation, which is longer than the time for capture gamma ray emission to cease.

15. The method of claim 14, wherein the measuring of the scattered gamma rays is performed after the emission of inelastic and capture gamma rays has decreased to less than 1% of the activation gamma ray emission.

16. The method of claim 12, wherein the property of the formation is a formation density.

17. The method of claim 12, wherein the property of the formation is a formation photoelectric factor.

18. The method of claim 12, wherein an additional gamma ray detector, shielded from the gamma rays emitted from the activation source is used to determine a signal from formation and borehole activation.

19. The method of claim 18, wherein a signal from formation and borehole activation is used to correct a measurement signal in at least one of the at least two gamma ray detectors.

20. The method of claim 12, wherein the at least two gamma ray detectors measure gamma rays from the scattering of gamma rays emitted by the activation source.

21. The method of claim 20, wherein the measurement of the at least two gamma ray detectors is combined with one or more neutron based measurements selected from the group consisting of a neutron capture spectroscopy measurement, a neutron inelastic gamma ray measurement, a neutron porosity measurement, a neutron gamma density measurement and a measurement of the macroscopic thermal neutron capture cross section of the formation.

22. The method of claim 21, wherein the neutron measurements are trailing the neutron source with respect to the direction of tool motion during the neutron measurement and the measurements of the at least two gamma ray detectors are leading the neutron source with respect to the direction of the tool motion during the activation source based measurements.

23. The method of claim 21, wherein the neutron measurements are collocated with the activation source based measurements at a same axial side with respect to the neutron generator.

24. A method to perform a mud density measurement in a flow channel, flow tube or tool cavity downhole using an activation source as the source of gamma rays, the method comprising:
generating neutrons in a neutron generator;
activating material surrounding the neutron generator to form a radioisotopic source, using the neutrons from the neutron generator;
irradiating mud in the mud channel, flow tube or tool cavity with gamma ray radiation from the radioisotopic source;
measuring transmitted gamma rays in at least one gamma ray detector;
in a processor determining a property of the mud based on measurements of the at least one gamma ray detector.

25. The method of claim 24, wherein the neutron generator is a pulsed neutron generator.

26. The method of claim 25, wherein the pulsed neutron generator operates according to a neutron pulsing scheme, which includes a gap in the neutron generation, which is longer than the time for capture gamma ray emission to cease.

27. The method of claim 25, wherein the measurement of the transmitted gamma rays is performed after the emission of inelastic and capture gamma rays has ceased.

28. The method of claim 24, wherein a gamma ray monitor is coupled to the activation material to allow normalization of gamma ray output.

29. The method of claim 24, wherein the property is selected from the group consisting of mud density and mud photoelectric effect.

30. The method of claim 24, wherein at least one additional detector is used to measure gamma rays from activation not related to the activation of the target and to provide a correction signal for the mud property measurement.

31. The method of claim 24, wherein the activation material is in close proximity to the mud channel, flow channel or tool cavity.

32. The method of claim 24, wherein the activation material is mounted inside the mud channel, flow channel or tool cavity in a mandrel tool configuration and at least one gamma ray detector is mounted outside a mandrel in a collar surrounding the mandrel.

33. The method of claim 32, wherein an activation monitor is mounted in the collar and wherein a gap formed by the mud channel between an activation target and an activation monitor is filled with a gamma ray transparent material.
